(19) United States
(12) Patent Application Publication
(10) Pub. No.: US 2004/0251743 A1
(43) Pub. Date: Dec. 16, 2004

(54) Control system for electrical devices in a vehicle

(76) Inventors: Walter Sadowski, Newington, CT (US); Joseph Smith, Unionville, CT (US); Richard Sorenson, Stuart, FL (US)

Correspondence Address: McCormick Paulding & Huber, City Place II, 185 Asylum Street, Hartford, CT, 06103-3402, US

(21) Appl. No.: 10/486,434

(22) PCT Filed: Aug. 8, 2002
(86) PCT No.: PCT/US02/25303

Related U.S. Application Data
(60) Provisional application No. 60/310,922, filed on Aug. 8, 2001.

(51) Int. Cl. B60L 3/00

(52) U.S. Cl. 307/10.1

(57) ABSTRACT

A control system for electrical devices in a vehicle has output/relay modules with processing and memory capability. The output/relay module is programmable to store configuration data corresponding to predetermined states for the various devices to be controlled. The output/relay module has memory capability including a non-volatile component (EEROM). An input module also has processing capability, and includes memory capability. The input module has selector switches for preselecting a variety of device states. The input module further provides a visual indication of the states for these devices. A data bus provides communication between said input and output modules, and a dongle is selectively connected to said relay module data bus for allowing changes to the configuration data stored therein. The dongle is programmable from a personal computer or work station. The control system includes a voltage monitoring system and circuit breakers to protect the system and devices controlled thereby.

### CROSS REFERENCE TO RELATED APPLICATIONS

The present application is related to the following co-pending applications, namely, PCT application number PCT/US01/03941 of Carling Technologies et al. for Apparatus For Electrically Controlling Devices And A Method Of Operating It, filed on Feb. 7, 2001 (Atty. Docket No. 1961-181WO), and U.S. Provisional Application No. 60/310,922 for System and Method For Controlling Electrical Devices, filed on Aug. 8, 2001, (Atty. Docket No. 1961-183), both of which are incorporated herein by reference.

### SUMMARY OF THE APPARATUS FOR ELECTRICALLY CONTROLLING DEVICES AND A METHOD OF OPERATING IT

The Apparatus For Electrically Controlling Devices And A Method Of Operating It disclosed in PCT patent application No. PCT/US01/03941 of Carling Technologies et al. provides a control system for electrical devices in a vehicle having output/relay modules with processing and memory capability including non-volatile memory. The output/relay modules are programmable and store configuration data corresponding to predetermined states for various devices to be controlled by the system. The output/relay modules each have outputs including relays coupled to the various electrical devices to be controlled on a vehicle such as lights, motors and pumps. The system provides at least one input module having a microprocessor and a plurality of variable function switches for selecting predetermined states for the electrical devices or relay modules. The input modules have visual indicators for providing the current states of the devices. A data bus provides communication between the input and output/relay modules. A clock provides synchronization for the transmission of serial data via the data bus.

The system also includes a dongle which can be programmed via a computer to store configuration data for a specific arrangement of the relationship between the input modules, the output/relay modules and the electrical devices to be controlled by the system. Once programmed, the dongle can be coupled to an output/relay module of the control system to configure or reconfigure the non-volatile memory of the system for a specific application.

The output/relay modules are configured via a jumper provided to function as either a master or slave output/relay such that the control system is extendable for control of any number of electrical devices by configuring a first output/relay module as a master and a plurality of additional output/relay modules as slave modules thereto.

The system provides for selectively configuring the variable function switches to implement a primary or secondary functions or both primary and secondary functions for controlling the relay modules or electrical devices coupled thereto. The switches include visual indicators for identifying the functional configuration thereof as well as a current status of the electrical devices. The switches can function as momentary or toggle switches and be configured in the following modes: inclusive scroll, exclusive scroll, binary scroll, intermittent, intermittent period increment, intermittent period decrement, as well as clone or timer modes.

### SUMMARY OF THE INVENTION

The present invention control system for electrical devices incorporates a control system such as the above-identified Apparatus For Controlling Electrical Devices In Vehicles and includes additional features. The additional features provide improvements to the above-identified system for use in vehicles such as yachts, motor homes, or airplanes wherein numerous electrical devices are utilized in the operation of the vehicle.

The invention provides a control system for electrical devices in a vehicle including a power supply, a relay module having a microprocessor with a memory and an output for controlling the electrical devices. The relay module is programmable for storing configuration data corresponding to predetermined states for the electrical devices to be controlled. The memory includes non-volatile memory (EEROM) or flash memory. The input module is coupled to the relay module via a data bus and includes a microprocessor and a plurality of variable function switches for selecting predetermined states for the electrical devices. The system includes a jumper for configuring the relay module and a programmable dongle connectable to said relay module for configuring the non-volatile memory.

The present invention control system for electrical devices in vehicles also includes a voltage monitoring system coupled to the microprocessor for monitoring the output voltage of the power supply and providing selective control of the electrical devices. In the event of a low voltage condition, the voltage monitoring system utilizes predetermined priority levels for each of the electrical devices controlled and shuts down the electrical devices accordingly, beginning with the lowest priority devices. The voltage monitoring system also includes a manual override for each of the electrical devices wherein the electrical devices can be shut down manually. The system stores predetermined default parameters for each of the electrical devices controlled that are also utilized in the shut-down procedures.

The present invention control system includes circuit breakers for protecting the system and electrical devices controlled thereby. The circuit breakers can be auto resettable such that the control system can reset a tripped breaker. Sensors are coupled to the circuit breakers for transmitting signals to indicators provided to communicate the status of the circuit breakers. Both audible and visual indicators can be utilized depending on the priority levels of the devices being controlled.

Additional features of the control system of the present invention are described in the following detailed description of a preferred embodiment of the invention wherein the control system is adapted for use in a boat.

### BRIEF DESCRIPTION OF THE DRAWINGS

FIG. 1 is a block diagram of an embodiment of the present invention;

FIG. 2 is a block diagram of the relay module of the FIG. 1 embodiment shown coupled to a dongle for configuring a relay module for use in a particular application;

FIG. 3 is an illustration showing the dongle of the above-identified Apparatus For Electrically Controlling Devices coupled to a computer for storing configuration information for the relay modules;

FIG. 4 shows a housing embodying the present invention control system;

FIG. 5 is a top view of a button module or operator control module for use with the present invention;

FIG. 6 is an illustration of a keypad switch having a removable button for use with the present invention;

FIG. 7 is a flowchart of a start-up function for use with the invention;

FIG. 8 is a flowchart illustrating the normal operation of an embodiment of the present invention;

FIGS. 9A-9C are flowcharts of typical automatic functions of the invention;

FIG. 10 is a flowchart illustrating the operation of the voltage monitoring system of one embodiment of the present invention; and

FIG. 11 is an illustration showing the interface panel controller of the present invention.

### DETAILED DESCRIPTION OF THE PREFERRED EMBODIMENT

Following is a description of a preferred embodiment of the present invention control system for electrical devices that was designed for use in vehicles. Other embodiments of the invention and applications therefor are within the scope of the invention and will be apparent to those skilled in the art upon review of the description and drawings of the invention included herein.

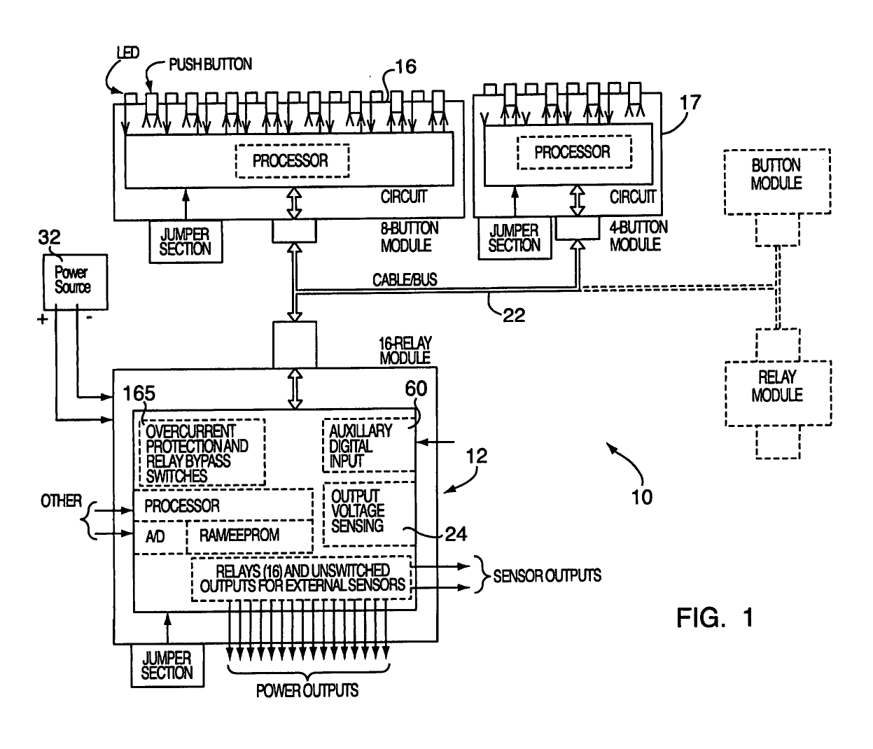

FIG. 1 shows the present invention control system for electrical devices generally referred to with the reference numeral 10 as used with the above-identified Apparatus For Electrically Controlling Devices. The operation and features of the Apparatus For Electrically Controlling Devices is described briefly hereinabove and in detail in the above referenced PCT patent application. Thus, the basic operation of the relay/output module generally 12, button modules 16 and 17 respectively and data bus 22 are not described further herein. However, the present invention improvements to the relay module 12 and button modules 16 and 17 are described following.

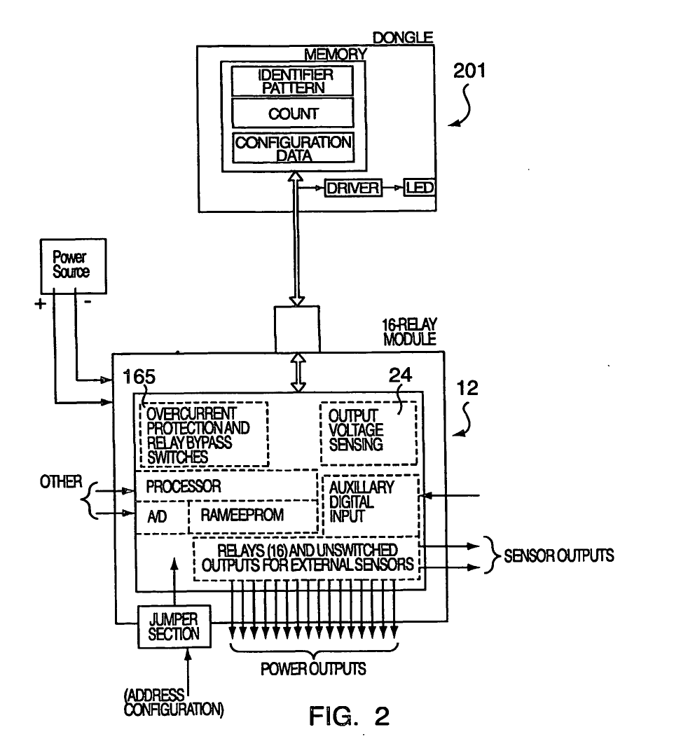

FIG. 2 is an illustration of the relay module 12 of the present invention coupled to the dongle, generally 201 in the same manner described in the above-identified Apparatus For Electrically Controlling Devices.

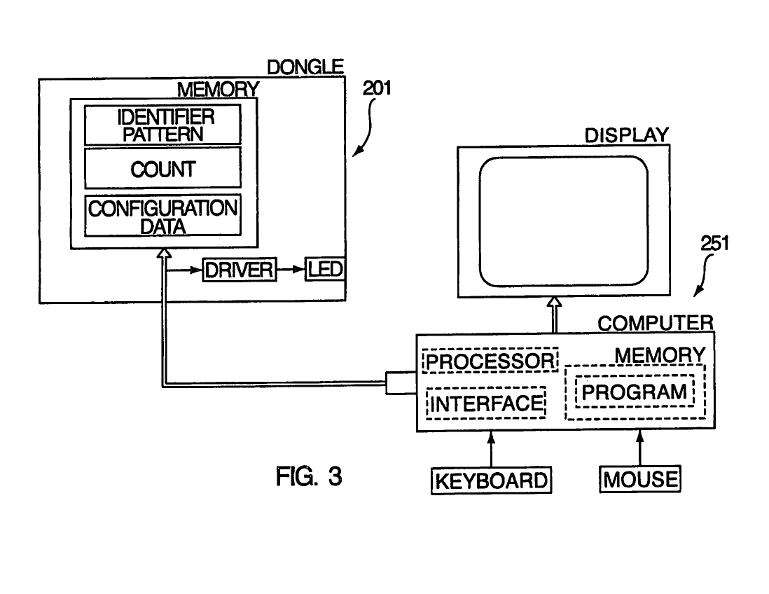

FIG. 3 is an illustration of the dongle 201 coupled to a computer, generally 251 for storing the configuration data for use in the relay module 12 in the memory of the dongle. This process is described in detail in the above-identified patent application for Apparatus For Electrically Controlling Devices, thus FIG. 3 is included herein for convenience only.

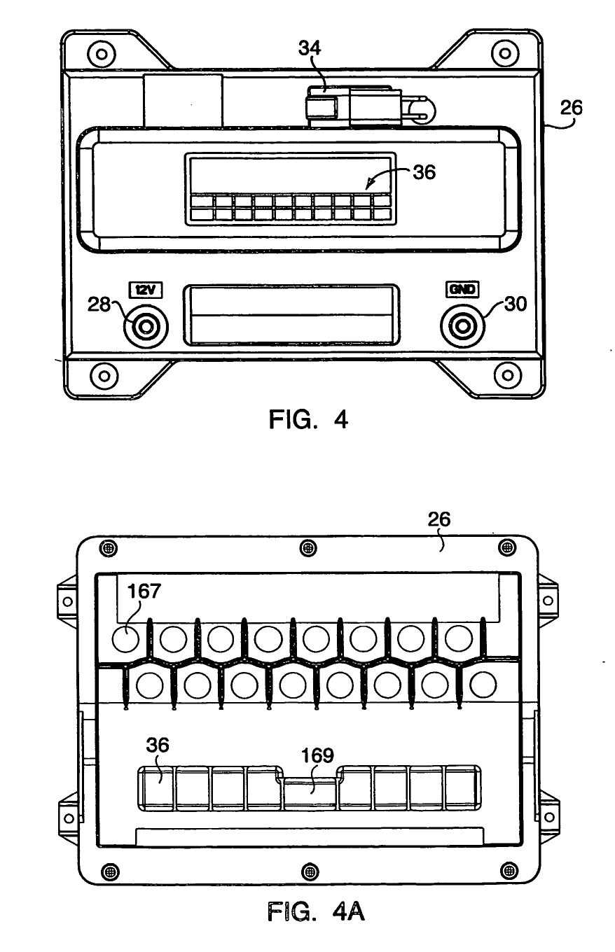

FIG. 4 shows a housing 26 for the control system 10 as used in the preferred embodiment of the present invention. The housing 26 has terminals 28 and 30 for coupling the control system 10 to the power supply 32. The coupler 34 is provided to attach the system to the bus 22. Manual override switches, generally referred to by the reference numeral 36 are further described hereinbelow.

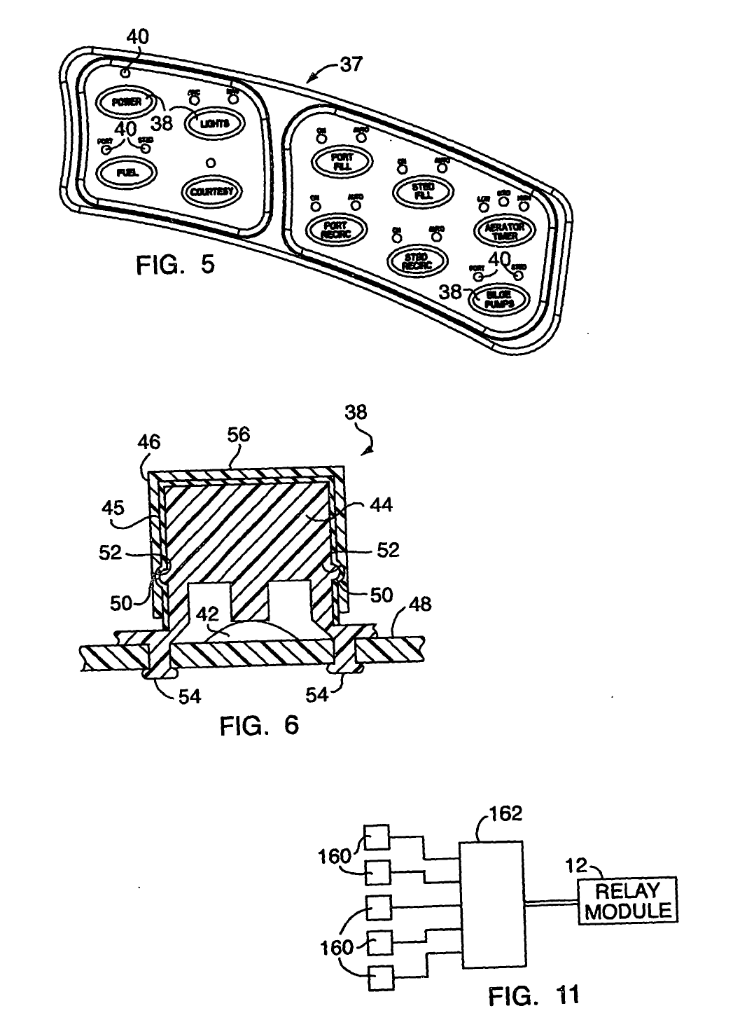

FIG. 5 shows a top view of an operator control module of the preferred embodiment of the present invention generally referred to by the reference numeral 37. The operator control module 37 has a plurality of variable function keypad switches 38 for operation of the electric devices of the vehicle (not shown) that are coupled to the control system. Indicator lights, 40, which are LEDS in the preferred embodiment shown, each correspond to the individual keypad switches 38. The keypad switches 38, can have one, two, or any number of indicator lights 40 associated therewith. Audible indicators (not shown) can also be utilized with the control system and activated thereby for indicating the status of certain of the electrical devices. The operation of operator control module 36 is described in detail in the above-described patent application for Apparatus For Electrically Controlling Devices.

In the preferred embodiment, the operator control module 37 is manufactured such that the module 37 has a membrane for providing a completely sealed unit for long term use in applications involving adverse conditions. The sealed units can be customized using removable switch covers that can include custom legends corresponding to the function of the switch or the device being controlled. The removable switch covers for the keypads provide flexibility for adapting standard keypads for various applications. The switch covers may include translucent etched legends for LED lighting of the customized switches or other means for providing illuminated switches having customized legends and visual indicators for displaying the status of the switches or electrical devices controlled thereby.

FIG. 6 shows details of one embodiment of a keypad switch 38 having a removable cover. A contact switch 42 is manually operated by using the button switch 44 which includes a removable cover 46. The button cover 46 couples to the switch 44 via detents 50 thereon and cooperating openings 52 in the button cover 46. The button switch 44 has a membrane 45 for sealing the switch and is coupled to a circuit board 48 via anchors 54. The button cover 46 is removable so that indicia on a top side 56 of the button cover can be easily changed or customized depending on the particular application or electrical device the operator control module 37 or keypad switch 38 is used to control. Additionally this allows the button cover 46 to be color coded to correspond to certain devices or for other purposes.

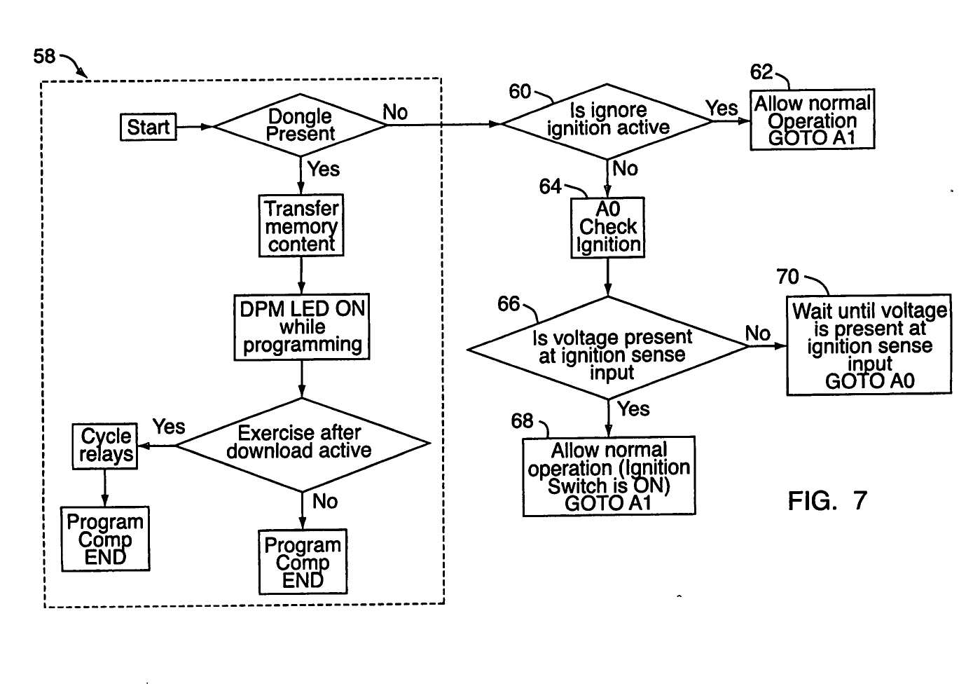

Referring to FIG. 7, a flowchart for the start-up procedure for the present invention control system is shown. The reference numeral 58 illustrates that portion of the start-up procedure that includes memory transfer from the dongle 201 and a self-test procedure, both of which are described in detail in the previously identified patent application for Apparatus For Electrically Controlling Devices. In the present invention, the relay modules 12 are initially configured using defaults for the variable parameters associated with the various functions of the relays and the operator control modules. For example the variable functional switches set to provide an intermittent function for a flashing light may be pre-set to activate the appropriate relays at 30 second intervals, wherein an intermittent switch designated to operate a live well on a fishing boat may have a preset parameter for intermittent operation in 10 minute intervals.

The present invention also provides an ignore ignition feature operable using an input pin on the relay module 12. Referring again to FIG. 7, the ignore ignition feature is illustrated starting at block 60 wherein a determination is made as to whether or not the ignore ignition feature is activated. If activated, as indicated in block 62, the control system 10 is operational regardless of the position of the vehicle's ignition-switch. Alternatively, if the ignore ignition in an inactive position, the vehicle's ignition switch is checked as shown in block 64. At block 66 a determination is made as to whether or not the ignition switch is on. If the ignition switch for the vehicle is on, then the control system 10 is activated for normal operation as indicated at block 68. Block 70 represents the condition wherein the ignore ignition feature is deactivated and the ignition switch is off, thus, the system returns to block 64 and rechecks the status of the ignition switch. The ignore ignition feature is utilized for operating the control system and electrical devices powered thereby when the ignition for the vehicle is in the off position. The ignore ignition feature can also be utilized for individual circuits wherein the appropriate relay modules 12 are configured accordingly. For example, the circuit for a stereo may be configured to operate only when the ignition is on thus ignore ignition would be deactivated. Alternatively, a circuit controlling a bilge pump may be configured to operate regardless of the status of the vehicle's ignition, thus ignore ignition is activated and the relay 12 would be configured accordingly.

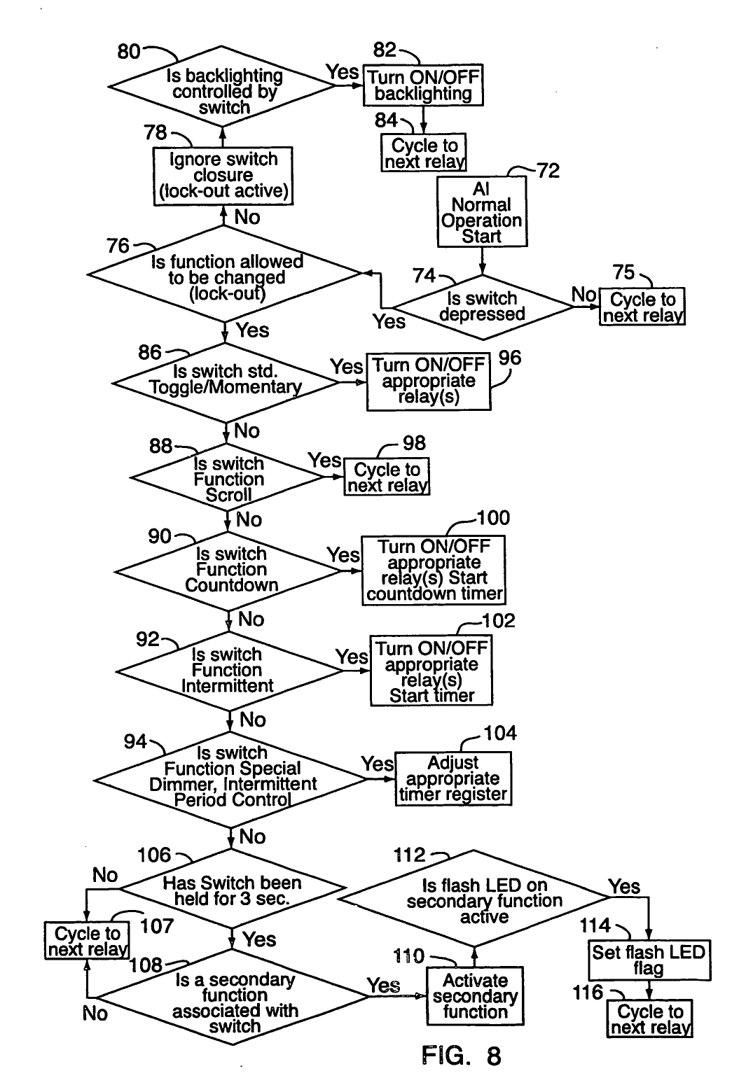

FIG. 8 is a flowchart illustrating the normal operation of the preferred embodiment of the invention. FIG. 8 shows the operation of the system starting at block 72. At block 74, the cycle begins at one of the keypad switches 38, wherein a determination is made as to whether or not the switch 37 has been depressed. If the switch has not been depressed the system cycles to the next relay in an infinite loop transversing each of the relays of the system 10, shown at block 75. If yes (the keypad switch 37 has been depressed), the block 76 represents a determination as to whether or not the function controlled by the depressed switch is allowed to be changed. This represents a lock-out feature of the control system wherein a function or device is prevented from being turned on or off depending on the status of on or more other functions or devices, (i.e. a port side ballast pump may be “locked-out” while a starboard ballast pump is active).

If the depressed switch controls a locked-out function, (lock-out active), shown in block 78, the switch closure is ignored. Next, the backlighting for the locked-out switch is checked at block 80 and adjusted accordingly at block 82. For example, the backlighting feature for the keypad switches may be configured to be turned off if the function of the switch is locked out. The control system 10 then cycles to the next relay as shown in block 84.

If the function controlled by the depressed switch 37 is not locked-out, the control system determines the functional operation of the switch at blocks 86, 88, 90, 92, and 94 respectively. Upon determination of the function of the switch 37, the appropriate relay is activated accordingly as shown in blocks 96, 98, 100, 102, and 104 for controlling the electrical devices.

Continuing at block 106, the system makes a determination if the switch has been depressed and held for at least 3 seconds. If no, the cycle advances to the next relay at block 107. If yes, a determination is made as to whether or not a secondary function is associated with the switch at block 108. If no, the cycle advances to the next relay at block 107. If there is a secondary function associated with the depressed switch 37, the secondary function is activated at block 110. The system 10 continues at block 112 and checks a flash indicator associated with the secondary function. The flash indicator is activated accordingly at block 114. The normal operation cycle of the system 10 continues to the next relay at block 116.

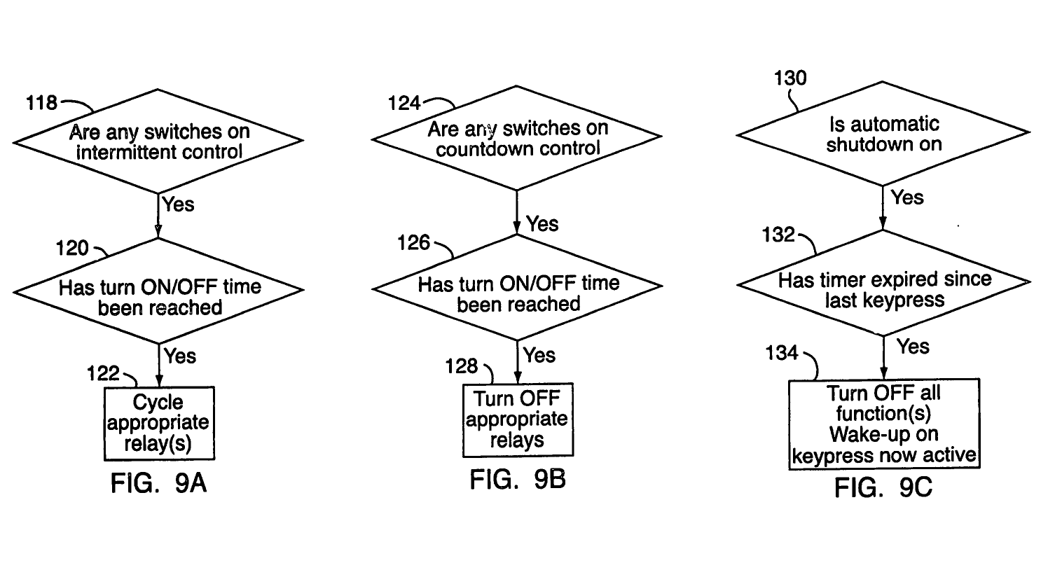

FIGS. 9A-9C illustrate the normal operation of some of the automatic or repetitive functions of the preferred embodiment of the control system 10 such as intermittent control (block 118), countdown control (block 124) and automatic shutdown (block 130). If the switch is configured to function intermittently, referring again to block 118, the system checks the appropriate timer at block 120 and upon reaching a predetermined time interval, the appropriate relay(s) is/are activated at block 122.

If the switch is configured in a countdown control (block 124), the timer is checked at block 126 and the appropriate relays are deactivated at block 128. Referring again to block 130, one embodiment of an automatic shut-down or sleep mode is illustrated. At block 132, a determination is made as to whether or not an appropriate timer has expired since the last keypad switch 37 was depressed. If yes, the control system or a portion thereof is shut-down at block 134 until the next time a keypad switch 37 is utilized. Alternatively, the control system can be shut-down manually.

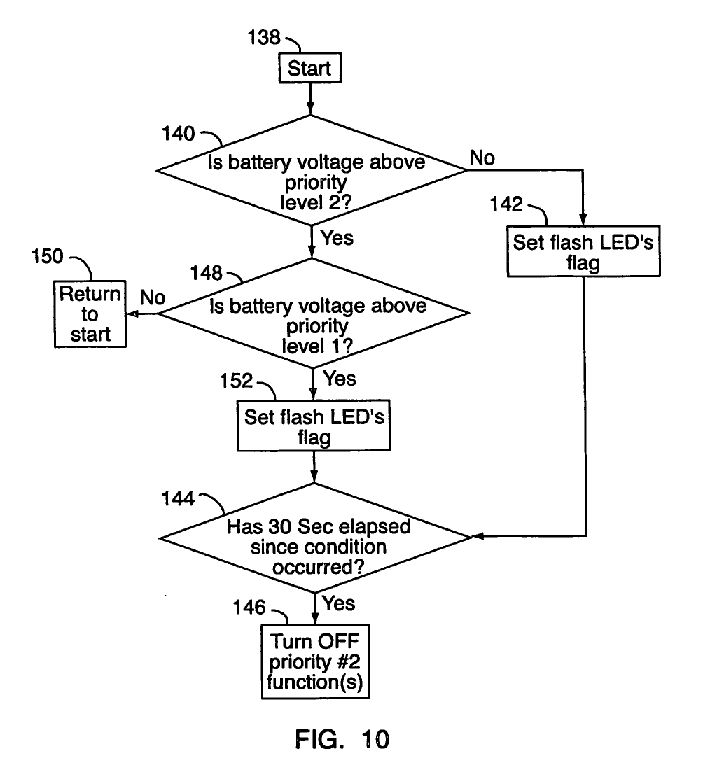

FIG. 10 illustrates one embodiment of the voltage monitoring system 24 of the control system 10. The present invention system 10 provides a voltage monitoring system 24 wherein the power supply 32 is continuously monitored and the voltage monitoring system provides selective control of the electrical devices of the vehicle accordingly. In the preferred embodiment, the control system functions properly in a voltage range of between about 9.5 volts to about 15 volts.

Each of the electrical devices is assigned a priority level that is stored in the memory of the system and utilized by the voltage monitoring system in automatic priority based shut-downs in the event of a low-voltage condition. For example, in the preferred embodiment, a priority level one is assigned to all of the most crucial devices in the vehicle, including any system that needs constant power such as a computer system or water system. A priority level two is assigned to devices that can be turned off, for example entertainment systems or certain power outlets. Additionally, in the preferred embodiment, the least critical devices are assigned a priority level three, for example, some non-emergency light fixtures may be assigned a priority level three.

The control system 10 provides manual override switches 36 shown in FIGS. 4 and 4A wherein certain functions or electrical devices can be operated manually regardless of the priority level thereof or the status of the voltage monitoring system 24. These manual override switches 36 are mainly designed for emergencies, however they could be utilized in other situations as well. The FIG. 4A embodiment also shows a main power switch 169 for the control system 10.

Additionally, each of the electrical devices has a proper voltage range associated therewith that is also stored in the system's memory and utilized to shut-down the particular component as necessary in a low-voltage situation to protect the device. Thus, each of the electrical devices has associated therewith parameters as to the safe operating range thereof as well as a priority level for the operation thereof. These parameters are normally preset to standard default values at the time of manufacture of the control system, however they are variable as necessary per the requirements of a certain application.

Referring again to FIG. 10, one embodiment of the voltage monitoring system 24 starts at block 138. At block 140, the voltage of the power supply 32 is compared to the priority level 2 voltage. If the power supply voltage is lower or equal to the priority level 2 voltage, warning indicators are activated at block 142. At block 144 a shut-down wait period timer is checked and allowed to elapse before the priority level 2 devices are shut down at block 146. Returning to block 140, if the voltage of the power supply 32 is above the priority 2 level, the voltage monitoring system 24 compares the power supply voltage to a priority one level at block 148. If the power supply voltage is above the priority one level, the voltage monitoring system 24 cycles to the start at block 138.

Alternatively, if the voltage of the power supply 32 is not above the priority level one voltage, warning indicators are activated at block 152 and the voltage monitoring system advances to block 144 wherein the shut-down timer for priority two level devices is checked prior to shut-down thereof.

FIG. 11 illustrates the use of electromechanical switches 160 coupled to the relay module 12 of the control system via an interface panel 162. The interface panel 162 is provided to couple switches 160 other than the keypad switches 38 on the operator control module 37 to the relay module 12. Thus, by using the interface panel 162 the control system 10 can function using standard switches. The control system 10 can utilize both the operator control modules 37 and standard switches coupled with the interface panel 162.

Referring to FIGS. 1 and 4A, the present invention control system includes overcurrent protection represented generally by the reference number 165 for protecting the system and electrical devices controlled thereby. Circuit breakers 167 are provided in the output circuitry and can be auto resettable such that the control system can reset a tripped breaker. Sensors are coupled to the circuit breakers 167 for transmitting signals to indicators provided to communicate the status of the circuit breakers. Both audible and visual indicators can be utilized depending on the priority levels of the devices being controlled. In the preferred embodiment the circuit breakers 167 are thermal breakers.

The programmable variable function switches can be programmed to provide each of the functions described in the previously identified patent application for Apparatus For Electrically Controlling Devices as well as other functions such as a wiper mode. The wiper mode eliminates the need for a standard wiper switch on vehicles equipped with the present invention control system for electrical devices. The wiper mode provides all of the standard controls normally used with windshield wipers such as low, high, mist and intermittent modes.

Other variable functions provided in the present invention control system include a reverse inclusive scroll mode wherein the switch is configured to turn off a series of electrical devices with repeated switch closings. Additionally a reverse binary scroll function is provided to turn off a series of electrical devices according to a decreasing binary count. A dimmer feature has been included in the present control system 10 for use with lighting devices as well as backlights for the operator control modules 37. Further, the relay module 12 of the present invention can be configured in a fixed on or fixed off mode such that a device can be always on or always off when the control system 10 is operating.

The preferred embodiment of the present invention also provides configurations for the relay module 12 for the specific control of bilge pumps used in boats. The relay module 12 for use with a bilge can include a manual override as identified above such that the bilge pump can be operated manually if necessary or desired. Additionally, the relay module 12 can be coupled to a float switch and configured to operate automatically based on the status of the switch. Visual indicators and audible warning devices can also be activated by the relay module 12 configured to control a bilge pump.

While preferred embodiments have been shown and described herein, various modifications and substitutions may be made without departing from the scope of the invention. Accordingly, it is to be understood that the present invention system and method for controlling electrical devices has been described herein by way of example and not by limitation.

We claim:

1. A control system for electrical devices in a vehicle comprising:
a power supply;
at least one relay module coupled to said power supply, said relay module comprising a first microprocessor having a memory and at least one output for controlling said electrical devices, said relay module being programmable to store configuration data corresponding to predetermined states for the electrical devices to be controlled, said memory comprising non-volatile memory (EEROM);
at least one input module comprising a second microprocessor, said input module having a plurality of variable function switches for selecting predetermined states for said devices;
a data bus for providing communication between said relay module and said input module;
a jumper for configuring said relay module;
a programmable dongle connectable to said relay module for configuring said non-volatile memory; and
a voltage monitoring system coupled to said first microprocessor for monitoring the output voltage of said power supply and providing selective control of said electrical devices.

2. A control system for electrical devices in a vehicle as defined in claim 1 wherein said voltage monitoring system utilizes a stored priority level for each of said electrical devices.

3. A control system for electrical devices in a vehicle as defined in claim 2 wherein said selective control of said electrical devices includes a prioritized shut-down thereof based on said priority levels.

4. A control system for electrical devices as claimed in claim 1 wherein said voltage monitoring system further comprises a manual override wherein said selective control of one or more of said electrically devices is operated manually.

5. A control system for electrical devices as claimed in claim 1 wherein said voltage monitoring system further comprises a sleep mode wherein a portion of the control system is shut down at a predetermined time or when inactive for a minimum period of time and restarted automatically or upon a manual restart.

6. A control system for electrical devices as claimed in claim 1 wherein said voltage monitoring system further comprises preset default parameters for each of said electrical devices for said selective control and shut-down thereof.

7. A control system for electrical devices as claimed in claim 1 wherein each said relay module is preset in a default configuration.

8. A control system for electrical devices in a vehicle as defined in claim 1 wherein said relay module is configurable to include a lock-out feature wherein the control of at least one of said electrical devices is dependent on an operational status of another of said electrical devices.

9. A control system for electrical devices in a vehicle comprising:
a power supply;
at least one relay module coupled to said power supply, said relay module comprising a first microprocessor having a memory and at least one output for controlling said electrical devices, said relay module being programmable to store configuration data corresponding to predetermined states for the electrical devices to be controlled, said memory comprising non-volatile memory (EEROM);
at least one input module comprising a second microprocessor, said input module having a plurality of variable function switches for selecting predetermined states for said devices;
a data bus for providing communication between said relay module and said input module;
a jumper for configuring said relay module;
a programmable dongle connectable to said relay module for configuring said non-volatile memory; and
a circuit breaker coupled to said relay module and said electrical devices for protecting the system and the devices controlled thereby.

10. A control system for electrical devices as claimed in claim 9 wherein said circuit breaker is automatically resettable.

11. A control system for electrical devices as defined in claim 9 wherein said circuit breaker is a thermal breaker.

12. A control system for electrical devices as defined in claim 9 further comprising a sensor for determining the status of said circuit breaker.

13. A control system for electrical devices as claimed in claim 12 further comprising at least one indicator coupled to said sensor for communicating the status of said circuit breaker.

14. A control system for electrical devices in a vehicle comprising:
a power supply;
a plurality of relay modules coupled to said power supply, each said relay module comprising a microprocessor having a memory and at least one output for controlling said electrical devices, said relay module being programmable to store configuration data corresponding to predetermined states for the electrical devices to be controlled, said memory comprising non-volatile memory (EEROM);
at least one input module comprising a microprocessor, said input module having a plurality of variable function switches for selecting predetermined states for said devices;
a data bus for providing communication between said relay modules and said input module;
a jumper coupled to each said relay module for configuration thereof;
a programmable dongle connectable to said relay modules for configuring said non-volatile memory; and wherein
at least one of said relay modules is configured to control a bilge pump.

15. A control system for electrical devices as defined in claim 14 wherein said relay module configured to control a bilge pump includes a manual override wherein the operation of said bilge pump can be controlled manually.

16. A control system for electrical devices as defined in claim 14 wherein said relay module configured to control a bilge pump is coupled to a float switch for control thereof.

17. A control system for electrical devices as defined in claim 14 further comprising at least one sensor coupled to said bilge pump for determining the operational state thereof.

18. A control system for electrical devices in a vehicle comprising:
a power supply;
at least one relay module coupled to said power supply, said relay module comprising a first microprocessor having a memory and at least one output for controlling said electrical devices, said relay module being programmable to store configuration data corresponding to predetermined states for the electrical devices to be controlled, said memory comprising non-volatile memory (EEROM);
at least one input module comprising a second microprocessor, said input module having a plurality of variable function switches for selecting predetermined states for said devices;
a data bus for providing communication between said at least one relay module and said input module;
a jumper for configuring said relay module; and wherein
at least a portion of said variable function switches further comprise a removable cover wherein said cover includes indicia describing the function of an electrical device controlled by said switch and wherein said removable cover is interchangeable on said input module such that said input module can be utilized for controlling various devices.

19. A control system for electrical devices in a vehicle comprising:
a power supply;
at least one relay module coupled to said power supply, said relay modules each comprising a first microprocessor having a memory and at least one output for controlling said electrical devices, said relay module being programmable to store configuration data corresponding to predetermined states for the electrical devices to be controlled, said memory comprising non-volatile memory (EEROM);
at least one input module comprising a second microprocessor, said input module having a plurality of variable function switches for selecting predetermined states for said devices;
a data bus for providing communication between said at least one relay module and said input module;
a jumper for configuring said relay module; and wherein
said input module further comprises an interface panel for coupling electromechanical switches to said microprocessor for selecting said predetermined states for said electrical devices.

20. (Canceled)

21. (Canceled)

22. (Canceled)
